(19) United States
(12) Patent Application Publication
(10) Pub. No.: US 2015/0232131 A1
(43) Pub. Date: Aug. 20, 2015

(54) ELASTICALLY AVERAGED ALIGNMENT SYSTEMS AND METHODS

(71) Applicant: GM GLOBAL TECHNOLOGY OPERATIONS LLC, Detroit, MI (US)

(72) Inventors: Steven E. Morris, Fair Haven, MI (US); Jennifer P. Lawall, Waterford, MI (US); Kee Hyuk Im, Rochester Hills, MI (US)

(73) Assignee: GM GLOBAL TECHNOLOGY OPERATIONS LLC, Detroit, MI (US)

(21) Appl. No.: 14/185,472

(22) Filed: Feb. 20, 2014

(51) Int. Cl. B62D 27/04

(52) U.S. Cl. CPC B62D 27/04

(57) ABSTRACT

In one aspect, an elastically averaged alignment system is provided. The elastically averaged alignment system includes a first component having an alignment member, and a second component having an inner wall defining an alignment aperture. The alignment aperture includes an insertion portion, a retention portion, and a transition portion therebetween. The alignment member is configured for insertion into the alignment aperture insertion portion and translation thereafter through the alignment aperture transition portion into the alignment aperture retention portion. The alignment member is an elastically deformable material such that when the alignment member is inserted into part of the alignment aperture, the alignment member elastically deforms to an elastically averaged final configuration to facilitate aligning the first component relative to the second component in a desired orientation.

### FIELD OF THE INVENTION

The subject invention relates to matable components and, more specifically, to elastically averaged matable components for alignment and retention.

### BACKGROUND

Components, in particular vehicular components used in automotive vehicles, which are to be mated together in a manufacturing process may be mutually located with respect to each other by alignment features that are oversized holes and/or undersized upstanding bosses. Such alignment features are typically sized to provide spacing to freely move the components relative to one another to align them without creating an interference therebetween that would hinder the manufacturing process. One such example includes two-way and/or four-way male alignment features; typically upstanding bosses, which are received into corresponding female alignment features, typically apertures in the form of slots or holes. The components are formed with a predetermined clearance between the male alignment features and their respective female alignment features to match anticipated size and positional variation tolerances of the male and female alignment features that result from manufacturing (or fabrication) variances.

As a result, significant positional variation can occur between two mated components having the aforementioned alignment features, which may contribute to the presence of undesirably large variation in their alignment, particularly with regard to gaps and/or spacing therebetween. In the case where misaligned components are also part of another assembly, such misalignment may also affect the function and/or aesthetic appearance of the entire assembly. Regardless of whether such misalignment is limited to two components or an entire assembly, it may negatively affect function and result in a perception of poor quality. Moreover, clearance between misaligned components may lead to relative motion therebetween, which may cause undesirable noise such as squeaking, rattling, and slapping.

### SUMMARY OF THE INVENTION

In one aspect, an elastically averaged alignment system is provided. The elastically averaged alignment system includes a first component having an alignment member, and a second component having an inner wall defining an alignment aperture. The alignment aperture includes an insertion portion, a retention portion, and a transition portion therebetween. The alignment member is configured for insertion into the alignment aperture insertion portion and translation thereafter through the alignment aperture transition portion into the alignment aperture retention portion. The alignment member is an elastically deformable material such that when the alignment member is inserted into part of the alignment aperture, the alignment member elastically deforms to an elastically averaged final configuration to facilitate aligning the first component relative to the second component in a desired orientation.

In another aspect, a vehicle is provided. The vehicle includes a body and an elastically averaged alignment system integrally arranged within the body. The elastically averaged alignment system includes a first component having an alignment member, and a second component having an inner wall defining an alignment aperture. The alignment aperture includes an insertion portion, a retention portion, and a transition portion therebetween. The alignment member is configured for insertion into the alignment aperture insertion portion and translation thereafter through the alignment aperture transition portion into the alignment aperture retention portion. The alignment member is an elastically deformable material such that when the alignment member is inserted into part of the alignment aperture, the alignment member elastically deforms to an elastically averaged final configuration to facilitate aligning the first component relative to the second component in a desired orientation.

In yet another aspect, a method of manufacturing an elastically averaged alignment system is provided. The method includes forming a first component having an alignment member, and forming a second component having an inner wall defining an alignment aperture. The alignment aperture includes an insertion portion, a retention portion, and a transition portion therebetween. The alignment member is configured for insertion into the alignment aperture insertion portion and translation thereafter through the alignment aperture transition portion into the alignment aperture retention portion. The method further includes forming the alignment member from an elastically deformable material such that when the alignment member is inserted into part of the alignment aperture, the alignment member elastically deforms to an elastically averaged final configuration to facilitate aligning the first component relative to the second component in a desired orientation

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of an exemplary elastic averaging alignment system before assembly;

FIG. 2A is a schematic plan view of a portion of the system shown in FIG. 1 in a first assembly position;

FIG. 2B is a schematic plan view of the system shown in FIG. 1 in a second assembly position;

FIG. 2C is a schematic plan view of the system shown in FIG. 1 in a third assembly position;

FIG. 3 is a cross-sectional view of the system shown in FIG. 2C and taken along line 3-3;

FIG. 4 is a schematic plan view of the system shown in FIG. 1 illustrating the first, second, and third assembly positions shown in FIGS. 2A-2C;

FIG. 5 is an alternative embodiment of an alignment aperture of the system shown in FIG. 1; and

FIG. 6 is a side view of a vehicle including the elastically averaged alignment system shown in FIGS. 1-5.

### DETAILED DESCRIPTION

The following description is merely exemplary in nature and is not intended to limit the present disclosure, its application or uses. For example, the embodiments shown are applicable to vehicle components, but the system disclosed herein may be used with any suitable components to provide securement and elastic averaging for precision location and alignment of all manner of mating components and component applications, including many industrial, consumer product (e.g., consumer electronics, various appliances and the like), transportation, energy and aerospace applications, and particularly including many other types of vehicular components and applications, such as various interior, exterior, electrical and under hood vehicular components and applications. It should be understood that throughout the drawings, corresponding reference numerals indicate like or corresponding parts and features.

As used herein, the term “elastically deformable” refers to components, or portions of components, including component features, comprising materials having a generally elastic deformation characteristic, wherein the material is configured to undergo a resiliently reversible change in its shape, size, or both, in response to the application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Elastic averaging provides elastic deformation of the interface(s) between mated components, wherein the average deformation provides a precise alignment, the manufacturing positional variance being minimized to Xₘᵢₙ, defined by Xₘᵢₙ=X/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675, published as U.S. Pub. No. 2013/0019455, the disclosure of which is incorporated by reference herein in its entirety. The embodiments disclosed above provide the ability to convert an existing component that is not compatible with the above-described elastic averaging principles, or that would be further aided with the inclusion of a four-way elastic averaging system as herein disclosed, to an assembly that does facilitate elastic averaging and the benefits associated therewith.

Any suitable elastically deformable material may be used for the mating components and alignment features disclosed herein and discussed further below, particularly those materials that are elastically deformable when formed into the features described herein. This includes various metals, polymers, ceramics, inorganic materials or glasses, or composites of any of the aforementioned materials, or any other combinations thereof suitable for a purpose disclosed herein. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS). The material may be in any form and formed or manufactured by any suitable process, including stamped or formed metal, composite or other sheets, forgings, extruded parts, pressed parts, castings, or molded parts and the like, to include the deformable features described herein. The elastically deformable alignment features and associated component may be formed in any suitable manner. For example, the elastically deformable alignment features and the associated component may be integrally formed, or they may be formed entirely separately and subsequently attached together. When integrally formed, they may be formed as a single part from a plastic injection molding machine, for example. When formed separately, they may be formed from different materials to provide a predetermined elastic response characteristic, for example. The material, or materials, may be selected to provide a predetermined elastic response characteristic of any or all of the elastically deformable alignment features, the associated component, or the mating component. The predetermined elastic response characteristic may include, for example, a predetermined elastic modulus.

As used herein, the term vehicle is not limited to just an automobile, truck, van or sport utility vehicle, but includes any self-propelled or towed conveyance suitable for transporting a burden.

Described herein are elastic averaging alignment systems and methods. The alignment systems include components with alignment aperture(s) to receive elastically deformable alignment member(s) of other components. The alignment aperture(s) each include an insertion portion, a final portion, and a transition portion therebetween. The alignment member is configured to be inserted into the insertion portion and thereafter translated through the transition portion into the retention portion. The alignment member(s) elastically deform to facilitate precisely aligning and securing the components together in a desired orientation.

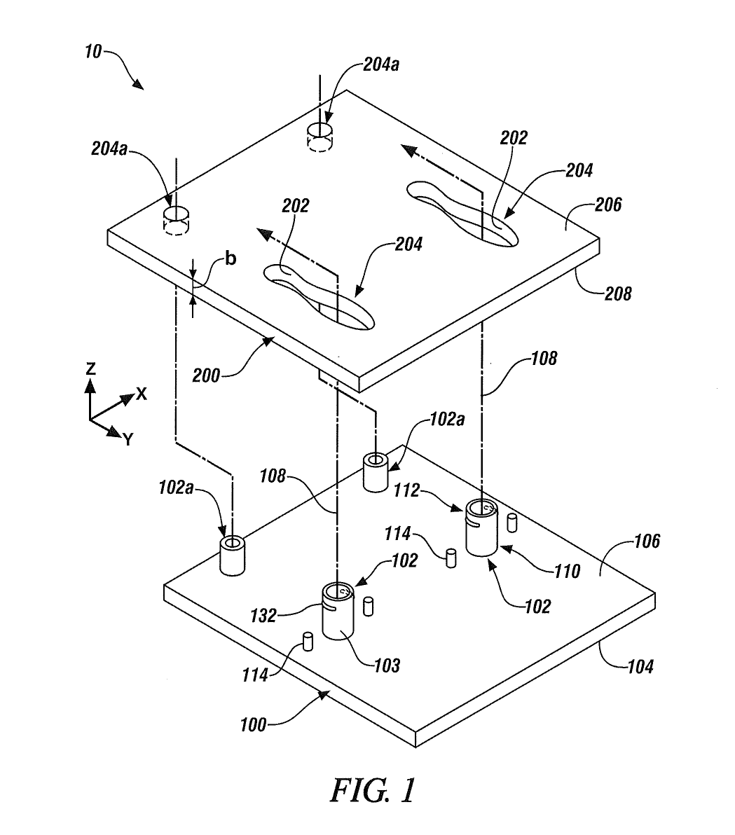

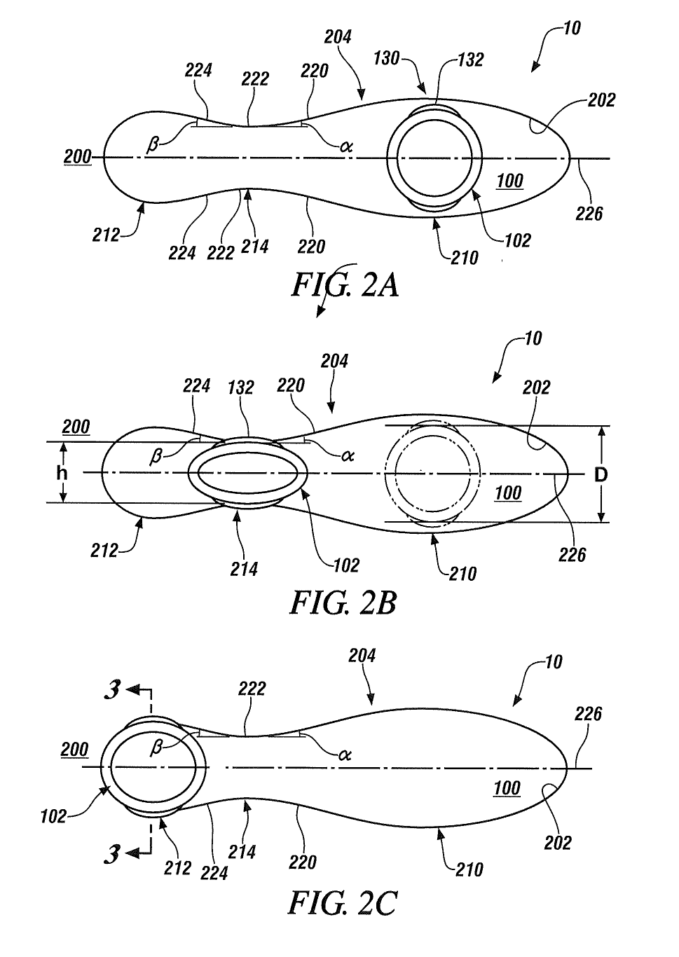

FIG. 1 illustrates an exemplary elastically averaged alignment system 10 that generally includes a first component 100 to be mated to a second component 200. FIGS. 2A-2C illustrate exemplary positions of first and second components 100, 200 during assembly of elastically averaged alignment system 10.

In the exemplary embodiment, first component 100 includes at least one elastically deformable alignment member 102, and second component includes an inner wall 202 defining at least one alignment aperture 204. Alignment member 102 and alignment aperture 204 are fixedly disposed on or formed integrally with their respective component 100, 200 for proper alignment and orientation when components 100 and 200 are mated. Although two alignment members 102 and corresponding alignment apertures 204 are illustrated in FIG. 1, components 100 and 200 may have any number and combination of corresponding alignment members 102 and alignment apertures 204. Further, as shown in FIG. 1, first component 100 may include additional alignment members 102a corresponding to additional alignment apertures 204a (different from apertures 204).

Elastically deformable alignment members 102, 102a are configured and disposed to interferingly, deformably, and matingly engage alignment aperture 204, 204a, as discussed herein in more detail, to precisely align first component 100 with second component 200 in two or four directions, such as the +/−x-direction and the +/−y-direction of an orthogonal coordinate system, for example, which is herein referred to as two-way and four-way alignment. Moreover, elastically deformable alignment member 102 matingly engages inner wall 202 of alignment aperture 204 to facilitate a stiff and rigid connection between first component 100 and second component 200, thereby reducing or preventing relative movement therebetween

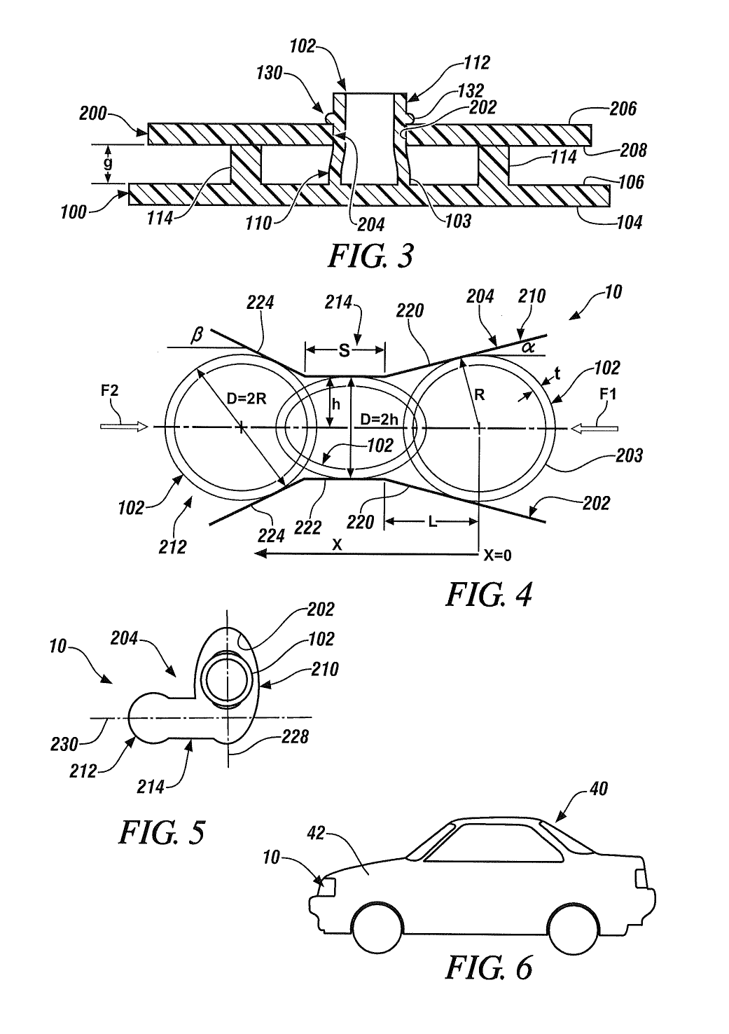

In the exemplary embodiment, first component 100 generally includes an outer face 104 and an inner face 106 from which alignment member 102 extends. Alignment member 102 is a generally circular hollow tube having a central axis 108, a proximal end 110 coupled to inner face 106, and a distal end 112. However, alignment member 102 may have any cross-sectional shape that enables system 10 to function as described herein. First component 100 may optionally include one or more stand-offs 114 (FIGS. 1 and 3) for engaging and supporting second component 200. In the exemplary embodiment, first component 100 is fabricated from a rigid material such as plastic. However, first component 100 may be fabricated from any suitable material that enables system 10 to function as described herein.

Second component 200 generally includes an outer face 206 and an inner face 208, and alignment aperture 204 includes three sections; an insertion portion 210, a retention portion 212, and a transition portion 214 therebetween. Alternatively, alignment aperture 204 may have any shape that enables system 10 to function as described herein. In the exemplary embodiment, second component 200 is fabricated from a rigid material such as sheet metal. However, second component 200 may be fabricated from any suitable material that enables system 10 to function as described herein.

While not being limited to any particular structure, first component 100 may be a decorative trim component of a vehicle with the customer-visible side being outer face 104, and second component 200 may be a supporting substructure that is part of, or is attached to, the vehicle and on which first component 100 is fixedly mounted in precise alignment. Alternatively, first component 100 may be an intermediate component located between second component support substructure 200 and a decorative trim component (not shown).

FIGS. 2A-2C illustrates exemplary positions of alignment member 102 within alignment aperture 204 during assembly of system 10. As shown in FIG. 2A, alignment member 102 is first inserted into insertion portion 210 of alignment aperture 204. Insertion portion 210 has a cross-section that is larger than a cross-section of alignment member 102 to provide clearance to allow alignment member 102 to be easily inserted into insertion portion 210. As shown in FIG. 2B, alignment member 102 is then translated through transition portion 214 of alignment aperture 204 toward retention portion 212 of alignment aperture 204. As illustrated in FIG. 2C, alignment member 102 is positioned in its final location within retention portion 212 to thereby couple first component 100 and second component 200.

To provide an arrangement where elastically deformable alignment member 102 is configured and disposed to interferingly, deformably and matingly engage alignment aperture 204, a cross-section of each of transition portion 214 and retention portion 212 is smaller than the diameter “D” or cross-section of alignment member 102, which necessarily creates a purposeful interference fit between the elastically deformable alignment member 102 and aperture retention portion 212 and transition portion 214. As such, when translated through transition portion 214 and subsequently into retention portion 212, portions of the elastically deformable alignment member 102 elastically deform to an elastically averaged final configuration that aligns alignment member 102 with portion 212 of the alignment aperture 204 in four planar orthogonal directions (the +/−x-direction and the +/−y-direction). Where retention portion 212 is an elongated slot (not shown), alignment member 102 is aligned in two planar orthogonal directions (the +/−x-direction or the +/−y-direction). Further, the cross-section of transition portion 214 is smaller than the cross-section of retention portion 212, which facilitates retention of alignment member within retention portion 212. Yet, alignment member 102 may be translated from retention portion 212 back through transition portion 214 into insertion portion 210 for disassembly of alignment system 10.

As shown in FIGS. 1-3, alignment member 102 may include one or more retention features 130 to facilitate retention of alignment member 102 within alignment aperture 204. In the exemplary embodiment, retention feature 130 is a lip or rib 132 extending from an outer wall 103 of alignment member 102 proximate distal end 112. Rib 132 extends at least partially about the circumference of outer wall 103 and is configured to engage outer face 206 and/or inner wall 202. For example, retention rib 132 interferingly engages outer face 206 to increase the amount of force required to disengage or otherwise remove alignment member 102 from within alignment aperture 204. Alternatively, retention feature 130 may have any suitable shape that enables system 10 to function as described herein. Accordingly, retention features 130 facilitate improved retention of alignment member 102 within alignment aperture 206.

While FIGS. 2 and 3 depict a single elastically deformable alignment member 102 in a corresponding alignment aperture 204 to provide four-way alignment of first component 100 relative to second component 200, it will be appreciated that the scope of invention is not so limited and encompasses other quantities and types of elastically deformable alignment elements used in conjunction with the elastically deformable alignment member 102 and corresponding alignment aperture 204. For example, as illustrated in FIG. 1, first component 100 includes additional elastically deformable alignment members 102a, and second component 200 includes additional corresponding alignment apertures 204a. While alignment apertures 204a are illustrated as having a generally circular cross-section, alignment apertures 204a may have any suitable shape that enables system 10 to function as described herein. For example, alignment aperture 204a may be an elongated slot (e.g., similar to the shape of elastic tube alignment system described in co-pending U.S. patent application Ser. No. 13/187,675 and particularly illustrated in FIG. 13 of the same).

Moreover, one or more standoffs 114 may be spaced relative to alignment member 102 such that they provide a support platform at a height “g” (FIG. 3) above first component inner face 106 upon which second component inner face 208 rests when elastically deformable alignment member 102 is configured and disposed to interferingly, deformably and matingly engage alignment aperture 204. Standoffs 114 are disposed and configured to provide a point of engagement between alignment aperture 204 and elastically deformable alignment member 102 at an elevation “g” above the base, inner face 106, of first component 100. While FIGS. 1 and 3 depict standoffs 114 in the form of posts at a height “g” relative to first component inner face 106, it will be appreciated that the scope of the invention is not so limited and also encompasses other numbers and shapes of standoffs 114 suitable for a purpose disclosed herein, and also encompasses a standoff in the form of a continuous ring disposed around alignment member 102. All such alternative standoff arrangements are contemplated and considered within the scope of the invention disclosed herein. Moreover, while FIGS. 1 and 3 depict standoffs 114 integrally formed on inner face 106, it will be appreciated that a similar function may be achieved by integrally forming standoffs 114 on second component inner face 208, which is herein contemplated and considered to be within the scope of the invention disclosed herein. Alternatively, system 10 may not include standoffs.

In the exemplary embodiment, portions of inner wall 202 are ramped or angled to provide an interference with alignment member 102 that requires a predetermined force to translate alignment member 102 therethrough. As best shown in FIGS. 2A-2C and 4, in the exemplary embodiment, portions or opposed walls 220 of inner wall 202 defining insertion portion 210 are ramped or angled and extend from transition portion 214 at an angle “α”. As such, opposed walls 220 converge as they extend toward transition portion 214 and intersect transition portion opposed walls 222. Angle “α” may be variably designed such that a predetermined force “F1” will be required to translate alignment member 102 from insertion portion 210 into transition portion 214. For example, as angle “α” is increased, force F1 required for alignment member translation is increased, and vice versa.

In the exemplary embodiment, portions or opposed walls 224 of inner wall 202 defining retention portion 212 are ramped or angled and extend from transition portion 214 at an angle “β”. As such, opposed walls 224 converge as they extend toward transition portion 214 and intersect opposed walls 222. Angle “β” may be variably designed such that a predetermined force “F2” will be required to translate alignment member 102 from retention portion 212 into transition portion 214. For example, as angle “β” is increased, force “F2” required for alignment member translation and removal is increased, and vice versa.

In the exemplary embodiment, angle “β” is greater than angle “α” such that the force required for alignment member removal from retention portion 212 is greater than the force required for alignment member insertion into retention portion 212. This facilitates ease of assembly, but removal requires a greater, purposeful force. Moreover, as alignment member 102 is translated from transition portion 214 to retention portion 212, opposed walls 224 diverge, which facilitates a negative force that pulls or urges alignment member 102 into retention portion 212. Similarly, during disassembly when alignment member 102 is translated from transition portion 214 to insertion portion 210, opposed walls 222 diverge, which facilitates a negative force that pulls or urges alignment member 102 into insertion portion 210.

With reference to FIG. 4, force “F1” required to assemble system 10 and translate alignment member 102 from insertion portion 210 into retention portion 212 for variable angle “α” is determined by the following equation:

$$F 1 = 2.24 * \frac{μ + tan α}{1 - μtanα} {Eb ( \frac{t}{R} )}^{3} * x sin α ,$$

where x=L−tan α, E=Young's Modulus, b=the thickness “b” of second component 200 (see FIG. 1), μ=coefficient of friction, and t=the tube wall thickness “t” of alignment member 102 (see FIG. 4). Similarly, force “F2” required to disassemble system 10 and translate alignment member 102 from retention portion 212 into insertion portion 210 for variable angle “β” is determined by substituting angle “β” for angle “α” in the equation above.

As shown in FIGS. 2A-2C, insertion portion 210, retention portion 212, and transition portion 214 are oriented or aligned on a common axis 226. FIG. 5 illustrates an alternative embodiment of alignment aperture 204 where insertion portion 210 and a portion of transition portion 214 are oriented or aligned on a first axis 228, and retention portion 212 and a portion of transition portion 214 are oriented or aligned on a second axis 230. In the exemplary embodiment, first axis 228 is substantially orthogonal to second axis 230. Alternatively, first axis 228 and second axis 230 may be oriented relative to each other at any angle that enables system 10 to function as described herein.

In view of the foregoing, and with reference now to FIG. 6, it will be appreciated that an embodiment of the invention also includes a vehicle 40 having a body 42 with an elastically averaging alignment system 10 as herein disclosed integrally arranged with the body 42. In the embodiment of FIG. 5, elastically averaging alignment system 10 is depicted forming at least a portion of a front grill of the vehicle 40. However, it is contemplated that an elastically averaging alignment system 10 as herein disclosed may be utilized with many other components of the vehicle 40, such as interior trim, instrument panel retainers and trim, multi-layer components, door trim, consoles, inserts, and exterior trim.

An exemplary method of fabricating elastically averaged alignment system 10 includes forming first component 100 with at least one alignment member 102, and forming second component with inner wall 202 defining at least one alignment aperture 204. Alignment member 102 is formed to be elastically deformable such that when alignment member 102 is inserted into or translated within alignment aperture 204, alignment member 102 elastically deforms to an elastically averaged final configuration to facilitate aligning first component 100 and second component 200 in a desired orientation.

In the exemplary embodiment, alignment aperture 204 is formed with insertion portion 210, retention portion 212, and transition portion 214 therebetween. Portions 220 and 224 of inner wall 202 may be ramped or angled, alignment member 102 may be formed with retention member 130 such as rib 132, and one or more standoffs 114 may be formed on first component 100 and/or second component 200.

Systems and methods for elastically averaging mating and alignment systems are described herein. The systems generally include a first component with an elastically deformable alignment member positioned for insertion into an alignment aperture of a second component. The mating of the first and second components is elastically averaged over each pair of corresponding alignment member and alignment aperture to precisely mate the components in a desired orientation. Moreover, the systems include multi-portion alignment apertures to facilitate retention of the alignment member within the alignment aperture, as well as allow removal of the alignment member therefrom. Accordingly, the described systems and methods facilitate precise alignment of two or more components in a desired orientation.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastically averaged alignment system comprising:
a first component comprising an alignment member; and
a second component comprising an inner wall defining an alignment aperture, the alignment aperture including an insertion portion, a retention portion, and a transition portion therebetween, wherein the alignment member is configured for insertion into the alignment aperture insertion portion and translation thereafter through the alignment aperture transition portion into the alignment aperture retention portion,
wherein the alignment member is an elastically deformable material such that when the alignment member is inserted into part of the alignment aperture, the alignment member elastically deforms to an elastically averaged final configuration to facilitate aligning the first component relative to the second component in a desired orientation.

2. The alignment system of claim 1, wherein the insertion portion has a cross-section larger than the retention portion, and the retention portion has a cross-section larger than the transition portion.

3. The alignment system of claim 2, wherein the insertion portion cross-section is larger than a cross-section of the alignment member.

4. The alignment system of claim 1, wherein the alignment member comprises at least one retention feature configured to engage the second component to facilitate retaining at least a portion of the alignment member within the alignment aperture.

5. The alignment system of claim 4, wherein the at least one retention feature is a rib extending from an outer surface of the alignment member.

6. The alignment system of claim 1, wherein the insertion portion, the transition portion, and the retention portion are oriented along a common axis.

7. The alignment system of claim 1, wherein the insertion portion and a first portion of the transition portion are oriented along a first axis, and the retention portion and a second portion of the transition portion are oriented along a second axis.

8. The alignment system of claim 7, wherein the first axis is orthogonal to the second axis.

9. The alignment system of claim 1, wherein a portion of the inner wall defining the insertion portion is ramped such that opposed walls of the ramped inner wall portion of the insertion portion converge as they extend towards the transition portion.

10. The alignment system of claim 9, wherein a portion of the inner wall defining the retention portion is ramped such that opposed walls of the ramped inner wall portion of the retention portion converge as they extend towards the transition portion.

11. The alignment system of claim 10, wherein the opposed ramped walls of the insertion portion are each oriented at a first angle, and the opposed ramped walls of the retention portion are each oriented at a second angle, the second angle larger than the first angle such that the force required to translate the alignment member from the retention portion to the transition portion is greater than the force required to translate the alignment member from the insertion portion to the transition portion.

12. The alignment system of claim 1, wherein the first component comprises more than one of the elastically deformable alignment member and the second component comprises more than one of the alignment aperture, the more than one elastically deformable alignment member being geometrically distributed with respect to respective ones of the more than one alignment apertures, such that portions of the elastically deformable alignment member of respective ones of the more than one elastically deformable alignment members, when engaged with respective ones of the more than one elastically deformable alignment apertures, elastically deform to an elastically averaged final configuration that further aligns the first component and the second component in at least two of four planar orthogonal directions.

13. A vehicle comprising:
a body; and
an elastically averaged alignment system integrally arranged within the body, the elastically averaged alignment system comprising:
a first component comprising an alignment member; and
a second component comprising an inner wall defining an alignment aperture, the alignment aperture including an insertion portion, a retention portion, and a transition portion therebetween, wherein the alignment member is configured for insertion into the alignment aperture insertion portion and translation thereafter through the alignment aperture transition portion into the alignment aperture retention portion,
wherein the alignment member is an elastically deformable material such that when the alignment member is inserted into part of the alignment aperture, the alignment member elastically deforms to an elastically averaged final configuration to facilitate aligning the first component relative to the second component in a desired orientation.

14. The alignment system of claim 13, wherein a portion of the inner wall defining the insertion portion is ramped such that opposed walls of the ramped inner wall portion of the insertion portion converge as they extend towards the transition portion.

15. The alignment system of claim 14, wherein a portion of the inner wall defining the retention portion is ramped such that opposed walls of the ramped inner wall portion of the retention portion converge as they extend towards the transition portion.

16. The alignment system of claim 15, wherein the opposed ramped walls of the insertion portion are each oriented at a first angle, and the opposed ramped walls of the retention portion are each oriented at a second angle, the second angle larger than the first angle such that the force required to translate the alignment member from the retention portion to the transition portion is greater than the force required to translate the alignment member from the insertion portion to the transition portion.

17. The vehicle of claim 13, wherein the first component comprises a plurality of the alignment members, and the second component comprises a plurality of the alignment apertures, each of the alignment members, when inserted into one of the alignment apertures, elastically deforms to an elastically averaged final configuration such that a manufacturing variance of each of the first and second components is averaged over the total of the alignment members.

18. A method of manufacturing an elastically averaged alignment system, the method comprising:
forming a first component comprising an alignment member;
forming a second component comprising an inner wall defining an alignment aperture, the alignment aperture including an insertion portion, a retention portion, and a transition portion therebetween, wherein the alignment member is configured for insertion into the alignment aperture insertion portion and translation thereafter through the alignment aperture transition portion into the alignment aperture retention portion; and
forming the alignment member from an elastically deformable material such that when the alignment member is inserted into part of the alignment aperture, the alignment member elastically deforms to an elastically averaged final configuration to facilitate aligning the first component relative to the second component in a desired orientation.

19. The method of claim 18, further comprising forming a portion of the inner wall defining the insertion portion to be ramped such that opposed walls of the ramped inner wall portion of the insertion portion converge as they extend towards the transition portion.

20. The method of claim 19, further comprising forming a portion of the inner wall defining the retention portion to be ramped such that opposed walls of the ramped inner wall portion of the retention portion converge as they extend towards the transition portion.
